(19) United States
(12) Patent Application Publication
(10) Pub. No.: US 2016/0338903 A1
(43) Pub. Date: Nov. 24, 2016

(54) Target-energy-directed Massager

(71) Applicant: Mengjun Yang, Beijing (CN)

(72) Inventor: Mengjun Yang, Beijing (CN)

(21) Appl. No.: 14/964,903

(22) Filed: Dec. 10, 2015

(30) Foreign Application Priority Data
May 21, 2015 (CN) 201510263954.6

(51) Int. Cl. A61H 23/02

(52) U.S. Cl. CPC A61H 23/0263

(57) ABSTRACT

Disclosed herein is a target-energy-directed massager comprising a target-energy-directed massager head (2), a vibration motor (4) and a directed-information-energy filler (6). An interior of the target-energy-directed massager head (2) is provided with the directed-information-energy filler (6), is covered and secured with a bottom cover of the massager (3), and is then securely connected to one end of the vibration motor (4). The presently disclosed massager overcomes the shortcoming of preexisting massagers and have more preciseness and target oriented specificity during disease treatment.

### TECHNICAL FIELD

The present invention relates to health care equipment, in particular to a target-energy-directed massager.

### BACKGROUND

Massage is a health treatment technique in traditional Chinese medicine. Massager is an alternative treatment or healthcare device using mechanical vibration by a motor. Existing massagers work generally through motor-driven mechanical vibration or tapping, kneading, and there is also massager that combines magnetic therapy, light therapy, heat (moxibustion) massage therapy, as well as massager with three-dimensional, or four-dimensional design. But these existing massagers disclosed provide only limited simple physical therapy to human bodies and an auxiliary rehabilitation and healthcare role, and they cannot provide targeted and precise treatment for different diseases. Thus the use of these massagers are limited.

### SUMMARY OF THE INVENTION

In order to overcome the above drawbacks of the massagers, the present disclosure provides a target-energy-directed massager with the following technical schemes.

The presently disclosed massager comprises a target-energy-directed massager head (2), a vibration motor (4) and a directed-information-energy filler (6). An interior of the target-energy-directed massager head (2) is provided with the directed-information-energy filler (6). A top surface of the target-energy-directed massager head (2) is provided with a plurality of pores (7). The plurality of pores (7) have diameters in the range of 0.01-2 mm, and an area size of >1 cm². A bottom of the target-energy-directed massager head (2) is provided with a bottom cover of the massager (3). The bottom cover of the massager (3) comprises a screw-type or click-type connector (8) which is configured to be connected to one end of the vibration motor (4). Another end of the vibration motor (4) is configured to be connected to the end cap (5). The target-energy-directed massager head (2) is provided with a front cover of the massager head (1).

The directed-information-energy filler (6) comprises a pharmaceutical drug, a mixture of pharmaceutical formulations, a pharmaceutical drug sponge, a pharmaceutical drug fabric, a pharmaceutical drug ceramic, a pharmaceutical drug plastic, a pharmaceutical drug rubber, or the combinations of the above. As used herein, a pharmaceutical drug is a substance comprising a single compound, compositions or biological products for the treatment or prevention of human disease or for promotion of health or beauty. The directed-information-energy filler (6) is disposed in the target-energy-directed massager head (2) and has no direct contact with a human skin, and has a distance of about 1-10 mm from a surface of human skin.

The vibration motor (4) provided herein is an apparatus with a vibration source comprising a motor, an impeller and an eccentric block. Vibration motors with a variety of vibration frequency and vibration specifications are commercially available.

Provided herein is also a method of using the massager after the assembly of the target-energy-directed massager head (2) and the vibration motor (4), and the method comprises: opening the front cover of the massager head (1), starting the vibration motor (4), placing the pore side of the target-energy-directed massager head (2) to a human skin to massage through vibration; running the massager 10-20 minutes each time and 1-2 times a day. After treatment, cover the target-energy-directed massager head (2) with the front cover of the massager head (1) and store in a sealed container.

Based on the principles and uses of different pharmaceutical drugs in the directed-information-energy filler (6), the present disclosure provides corresponding treatments of different diseases and rehabilitation care.

The beneficial effects of the present disclosure are as below.

First, the physical vibration frequency of a vibration motor (4) and energy of the information-energy filler (6) combines specifically, to achieve a superconducting targeted therapy by the information energy, and to realize the preciseness and specificity of therapy of diseases by the massager.

Second, the effect of the pharmaceutical drug is converted to effect of energy information superconducting. The drug substance during treatment is not in direct contact with a human body, and may have a distance of 0.01 mm from the skin, When in use the suspended state of the drug avoids the side effects of drugs.

Third, there is significantly improved clinical efficacy. After clinical application, its clinical efficacy of the massager is superior to a unit drug therapy and massage equipment treatment. The clinical application of the present invention during 200 weight loss cases has achieved an effective rate of 90%, therefore creating a new clinical techniques.

### BRIEF DESCRIPTION OF THE DRAWINGS

FIG. 1 is a schematic diagram showing the structure of a target-energy-directed massager. 1, front cover of the massager head; 2, target-energy-directed massager head; 3, bottom cover of the massager; 4, vibration motor; 5, end cap; 6, the directed-information-energy filler; 7, pores; 8, connector.

### DETAILED DESCRIPTION

### Embodiments

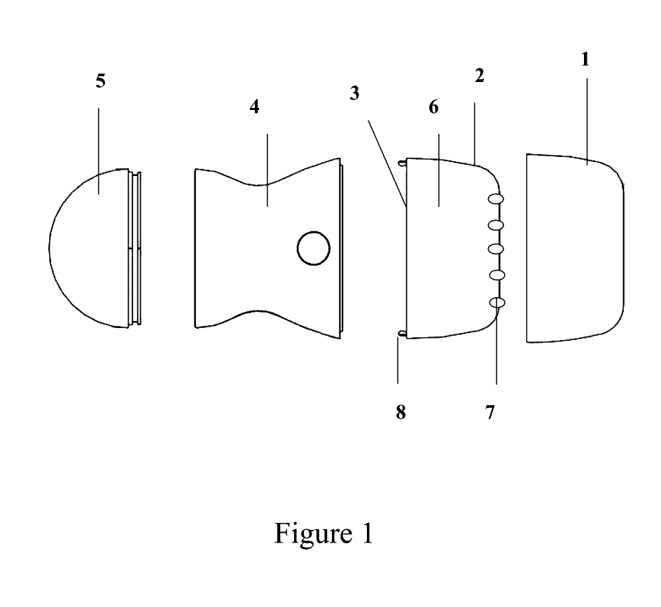

Below is a description of specific embodiments in conjunction with the accompanying drawings. FIG. 1 is a schematic diagram showing the structure of a target-energy-directed massager. The presently disclosed massager comprises a front cover of the massager head (1), a target-energy-directed massager head (2), a bottom cover of the massager (3), a vibration motor (4) and an end cap (5). An interior of the target-energy-directed massager head (2) is provided with the directed-information-energy filler (6). The directed-information-energy filler (6) comprises a pharmaceutical drug, a mixture of pharmaceutical formulations, a pharmaceutical drug sponge, a pharmaceutical drug fabric, a pharmaceutical drug ceramic, a pharmaceutical drug plastic, a pharmaceutical drug rubber, or the combinations of the above. A top surface of the target-energy-directed massager head (2) is provided with a plurality of pores (7). Pores (7) have diameters of 0.1 mm, and an area size of 2 cm². A bottom of the target-energy-directed massager head (2) is provided with the bottom cover of the massager (3). The bottom cover of the massager (3) comprises a screw-type or click-type connector (8) which is configured to be connected to one end of the vibration motor (4). Another end of the vibration motor (4) is configured to be connected to the end cap (5). The target-energy-directed massager head (2) is covered by the front cover of the massager head (1).

To implement, plastic molds may be generated according to the above-mentioned structure. Injection molding of the structure may be done by a plastic injection molding machine. In addition, fillers are prepared for providing the directed-information-energy filler (6). During manufacture, the directed-information-energy filler (6) is placed into the target-energy-directed massager head (2), and is covered by the bottom cover of the massager (3) with the connector (8), and then sealed by tightening or applying glues for fixing to complete the assembly of the target-energy-directed massager head (2). The connector (8) of the target-energy-directed massager head (2) is then connected to the vibration motor (4). Another end of the vibration motor (4) is connected to the end cap (5). When in use, connecting the vibration motor (4) to an electric power, turning on the vibration switch, and using the pore side of the target-energy-directed massager head (2) of the massager to massage on an acupuncture point on a human skin or a disease area.

What is claimed is:

1. A massager comprising a target-energy-directed massager head, a vibration motor, and a directed-information-energy filler; wherein an interior of the target-energy-directed massager head is provided with the directed-information-energy filler; wherein a top surface of the target-energy-directed massager head is provided with a plurality of pores; wherein the plurality of pores have diameters in the range of 0.01-2 mm, and an area size of >1 cm²; wherein a bottom of the target-energy-directed massager head is provided with a bottom cover of the massager; wherein the bottom cover of the massager comprises a screw-type or click-type connector which is configured to be connected to one end of the vibration motor; wherein another end of the vibration motor is configured to be connected to an end cap; wherein the target-energy-directed massager head is provided with a front cover of the massager head.

2. The massager of claim 1, wherein the directed-information-energy filler comprises a pharmaceutical drug, a mixture of pharmaceutical formulations, a pharmaceutical drug sponge, a pharmaceutical drug fabric, a pharmaceutical drug ceramic, a pharmaceutical drug plastic, a pharmaceutical drug rubber, or the combinations of the above; wherein the pharmaceutical drug is a substance comprising a single compound, compositions or biological products for the treatment or prevention of human disease or for promotion of health or beauty; wherein the directed-information-energy filler has no direct contact with a human skin, and has a distance of about 1-10 mm from a surface of human skin.

3. The massager of claim 1, wherein the vibration motor comprises a vibration source comprising a motor, an impeller and an eccentric block.
